(19) United States
(12) Patent Application Publication
(10) Pub. No.: US 2020/0400176 A1
(43) Pub. Date: Dec. 24, 2020

(54) BOLTED JOINT WITH DRUM-SHAPED SPHERICAL SHELL FOR CONNECTING CIRCULAR STEEL TUBE BRACE

(71) Applicant: TAIYUAN UNIVERSITY OF TECHNOLOGY, Taiyuan (CN)

(72) Inventors: Yajie Yan, Taiyuan (CN); Yunjing Nie, Taiyuan (CN); Honggang Lei, Taiyuan (CN); Bin Du, Taiyuan (CN); Cheng Luo, Taiyuan (CN)

(21) Appl. No.: 16/876,290

(22) Filed: May 18, 2020

(30) Foreign Application Priority Data
Jun. 24, 2019 (CN) 201910546383.5

(51) Int. Cl. F16B 9/02

(52) U.S. Cl. CPC F16B 9/02

(57) ABSTRACT

A bolted joint with a drum-shaped spherical shell for connecting a circular steel tube brace, including a drum-shaped spherical shell and N connecting members, connecting members each include a curved European nut, a bolt for space trusses, a sleeve, a sealing plate (or a conehead) and a circular steel tube. There are at least three forms: a corner drum, a half drum and a full drum. Specifications of the high-strength bolt for space trusses are determined, and the geometric dimensions, tensile and compressive bearing capacity of the joint are selected. The bolted joint has clear force transmission and a small deviation between theoretically analyzed stress and actual stress; has no eccentricity, can be finely adjusted and has reliable mechanical performance; is in bolted connection and is installed efficiently; and is not convex, thereby facilitating wallboard installation and indoor decoration.

### CROSS-REFERENCE TO RELATED APPLICATIONS

This application claims the benefit of Chinese Appl. No. 201910546383.5, filed Jun. 24, 2019. That application is incorporated herein by reference in its entirety to the extent consistent with the present application.

### TECHNICAL FIELD

The present invention belongs to the field of civil engineering construction, and particularly relates to a bolted joint with a drum-shaped spherical shell for connecting a circular steel tube brace.

### BACKGROUND

The most common joints for space structures with steel tubes are welded hollow spherical joints (WHSJ) and bolt spherical joints (BSJ). The WHSJ is implemented by directly welding a circular steel tube to a hollow sphere, and the hollow sphere has no directionality and can be connected with any circular steel tube in any direction. If a steel tube cutting surface is perpendicular to the axis of the circular steel tube, the circular steel tube can be naturally centered at the center of the sphere without eccentric connection, and the force transmission of the joint is clear. However, the WHSJ is prone to stress concentration at welding feet, and a large amount of high-altitude welding operation is required on the construction site, which makes it difficult to ensure the quality of the joint. The BSJ connects to a circular steel tube through a high-strength bolt, and the construction is convenient and fast; and each member can be subjected to standardized design, thereby meeting the requirements for building industrialization and production. However, the BSJ has a large self weight and requires high machining accuracy. An installation deviation easily causes eccentric force on the circular steel tube. During the installation process, the phenomena of “under-tightening” and “false-tightening” easily occur, which affects the bearing capacity of the joint.

According to the characteristics of the WHSJ and the BSJ, such as convenience in centering and high installation efficiency, a bolt connection joint suitable for the circular steel tube brace is designed to realize the assembly of the circular steel tube brace.

### SUMMARY

In order to solve the problems that the forgoing two joints have obvious stress concentration, which affects the bearing capacity of the joints, there are high requirements on joint processing precision and the construction process is complicated, the present invention provides a bolted joint with a drum-shaped spherical shell for connecting a circular steel tube brace.

The present invention is implemented by the following technical solution:

A bolted joint with a drum-shaped spherical shell for connecting a circular steel tube brace, including a drum-shaped spherical shell and a plurality of connecting members.

The drum-shaped spherical shell is formed by an upper-end circular plane cover plate, a lower-end circular and a part of plane spherical plate that are welded to each other. The center of the upper-end or lower-end circular plane cover plate is provided with a mounting hole, the spherical connecting surface is provided with one or more connecting holes, and centers of the plurality of connecting holes are positioned on the same connecting plane.

The connecting members each include a curved European nut, a high-strength bolt for space trusses, a sleeve, a sealing plate or a conehead and a circular steel tube, where the high-strength bolt for space trusses is pre-installed at one end of the circular steel tube through the sealing plate or the conehead, the sleeve sleeves the high-strength bolt for space trusses through a fastening screw, and a free end of the high-strength bolt for space trusses passes through the connecting holes in the spherical connecting surface of the drum-shaped spherical shell and then is fixed by the curved European nut.

The plurality of connecting members are centered on the spherical connecting surface of the drum-shaped spherical shell.

In use, the bolted joint with a drum-shaped spherical shell for connecting a circular steel tube brace is used as a plane connection joint. During assembly, the curved European nut is positioned at the connecting hole inside the spherical connecting surface through the mounting hole; the sleeve is fixedly connected to the preset high-strength bolt for space trusses through the fastening screw; the circular steel tube is fixedly connected to the drum-shaped spherical shell by the curved European nut and the high-strength bolt for space trusses, and N connecting members are centered on the outer surface of the drum-shaped spherical shell.

The present invention has the following beneficial effects.

1. The connection joint has clear force transmission and small deviation.

When the circular steel tube is under tension, a force transmission route of the joint is as follows: tension→steel tube→conehead or sealing plate→bolt→nut→drum-shaped spherical shell; and when the circular steel tube is under pressure, its force transmission route is: pressure→steel tube→conehead or sealing plate→sleeve→drum-shaped spherical shell.

2. The connection joint is convenient to center and has no eccentricity.

The circular steel tubes intersect on the drum-shaped spherical shell. Due to the unique centering performance of the spherical surface, it is convenient for the axis of each circular steel tube to intersect at the center of the sphere, and no eccentric stress occurs to the joint.

3. The connecting holes can be finely adjusted and easy to connect.

At the corresponding position of each circular steel tube, the diameter of an opening of the drum-shaped spherical shell is 2 mm greater than that of the high-strength bolt for space trusses. During installation, the circular steel tube can be finely adjusted around the center of the sphere at 360° to ensure that each circular steel tube is smoothly installed.

4. Bolted connection ensures high efficiency.

Each component of the joint is designed in a standardized, conventionalized and serialized way. The circular steel tube is connected to the drum-shaped spherical shell by a bolt and assembled on site with high efficiency.

5. The joint is not convex, which facilitates wallboard installation or secondary decoration.

The drum-shaped design frees the joint from any convex, which facilitates wallboard installation or secondary decoration.

The present invention has reasonable design, is a novel circular steel tube assembly joint, and has higher application values.

### BRIEF DESCRIPTION OF THE DRAWINGS

FIG. 1 is a schematic structural diagram of the present invention;

FIG. 2a is a schematic structural diagram of a connecting member (a sealing plate);

FIG. 2b is a schematic structural diagram of another connecting member (a conehead);

FIG. 3 is a front view of an unribbed drum-shaped spherical shell;

FIG. 3a is a sectional view of FIG. 3 taken along A₁-A₁;

FIG. 3b is a schematic view of FIG. 3 taken along A₂-A₂;

FIG. 4 is a front view of a ribbed drum-shaped spherical shell;

FIG. 4a is a sectional view of FIG. 4 taken along B₁-B₁;

FIG. 4b is a schematic view of FIG. 4 taken along B₂-B₂;

FIG. 5 is a front view of a curved European nut;

FIG. 5a is a sectional view of FIG. 5 taken along C₁-C₁;

FIG. 5b is a vertical view of FIG. 5 taken along C₂-C₂;

FIG. 6 is a schematic diagram of a sleeve;

FIG. 6a is a sectional view of FIG. 6 taken along D₁-D₁;

FIG. 7a is a sectional view of a sealing plate;

FIG. 7b is a sectional view of a conehead;

FIG. 8 is a front view of a high-strength bolt for space trusses;

FIG. 9a is a schematic diagram of a single layer brace;

FIG. 9a1 is a sectional view of a “corner drum” joint (joint 1);

FIG. 9a2 is a sectional view of a “half drum” joint (joint 2);

FIG. 9b is a schematic diagram of a double-layer brace;

FIG. 9b1 is a sectional view of a “half drum” joint (joint 3); and

FIG. 9b2 is a sectional view of a “full drum” joint (joint 4).

In the figure, 1. drum-shaped spherical shell, 2. curved European nut, 3. high-strength bolt for space trusses, 4. sleeve, 5. sealing plate, 6. conehead, 7. circular steel tube, 8. connecting member, 9. key groove (sliding groove JG/T October 2009), 10. double ribs, 11. circular plane cover plate, 12. spherical connecting surface, 13. mounting hole, 14. connecting hole.

### DETAILED DESCRIPTION

Specific examples of the present invention are described in detail below with reference to the accompanying drawings.

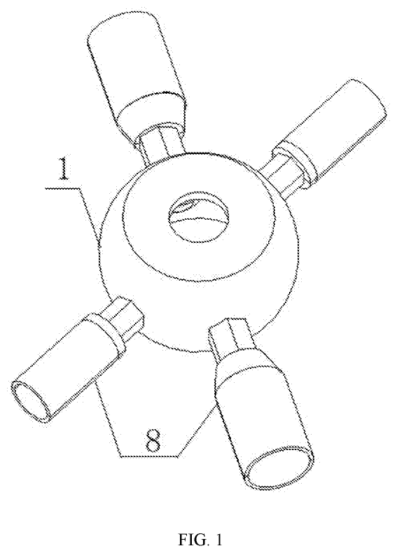

As shown in FIG. 1, a bolted joint with a drum-shaped spherical shell for connecting a circular steel tube brace includes a drum-shaped spherical shell 1 and N connecting members 8.

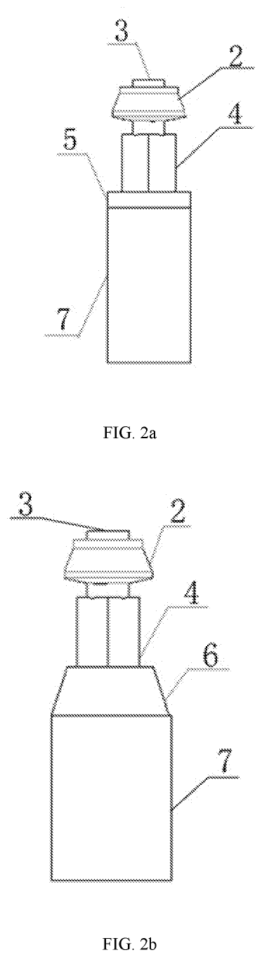

As shown in FIGS. 2a and 2b, the connecting members 8 each include a curved European nut 2, a high-strength bolt 3 for space trusses, a sleeve 4, a sealing plate 5 (or a conehead 6) and a circular steel tube 7, where one end of the circular steel tube 7 is fixedly connected to one end of the sealing plate 5 (or the conehead 6) (when the conehead is connected, a large-diameter end of the conehead is connected). The high-strength bolt 3 for space trusses is preset in a bolt hole of the sealing plate 5 (or the conehead 6), and the sleeve 4 is fixedly connected to the preset high-strength bolt 3 for space trusses through a fastening screw. A free end of the high-strength bolt 3 for space trusses passes through connecting holes 14 in a spherical connecting surface 12 of the drum-shaped spherical shell 1 and then is fixed by the curved European nut 2; and the circular steel tube 7 is fixedly connected to the drum-shaped spherical shell 1 by the curved European nut 2 and the high-strength bolt 3 for space trusses. If the centers of the plurality of connecting holes 14 are located in the same connecting plane of the spherical connecting surface 12, then the N connecting members 8 are centered on the outer surface of the drum-shaped spherical shell 1, which belongs to a same plane.

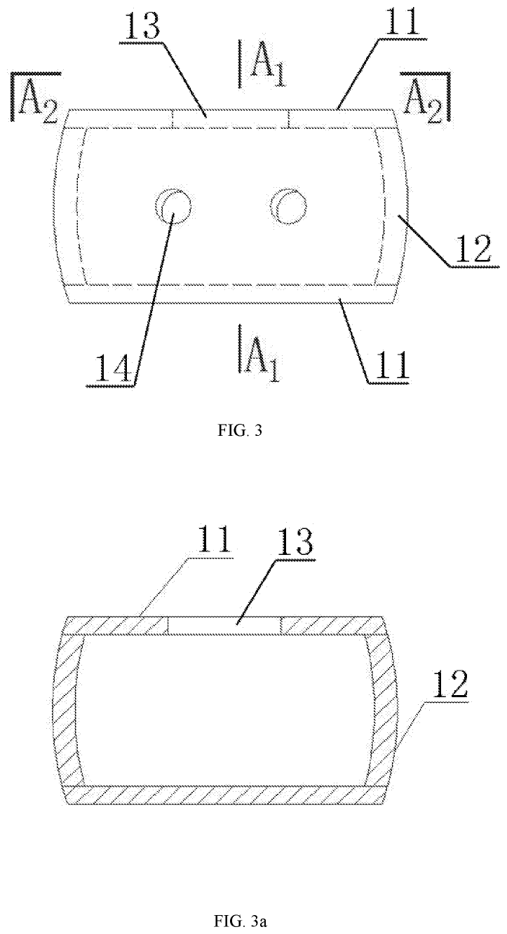

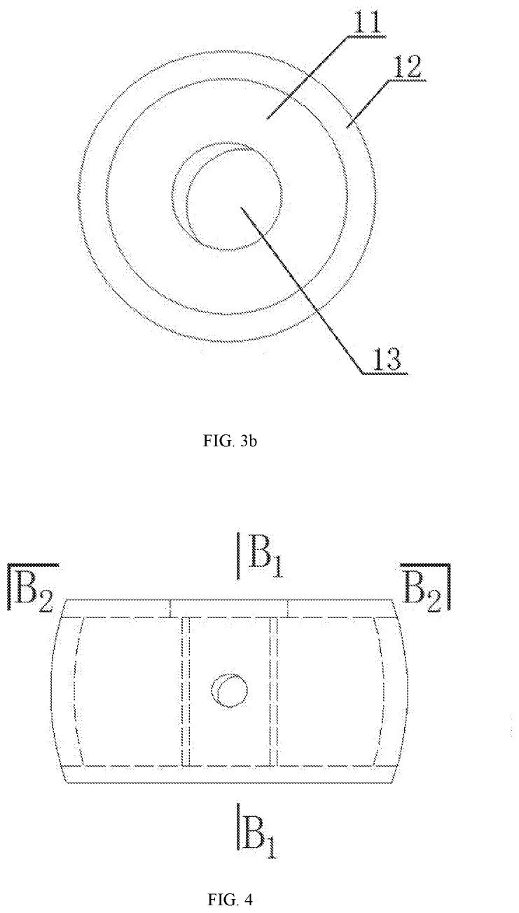

As shown in FIGS. 3 and 3a, the drum-shaped spherical shell 1 is composed of the spherical connecting surface 12 and circular plane cover plates 11 at two ends. A fully welded groove butt weld is adopted for the circular plane cover plates 11 and the spherical connecting surface 12, and a thickness t of the circular plane cover plate is greater than a wall thickness T of the spherical connecting surface, thereby effectively using the constraint effect of the cover plate on the spherical shell.

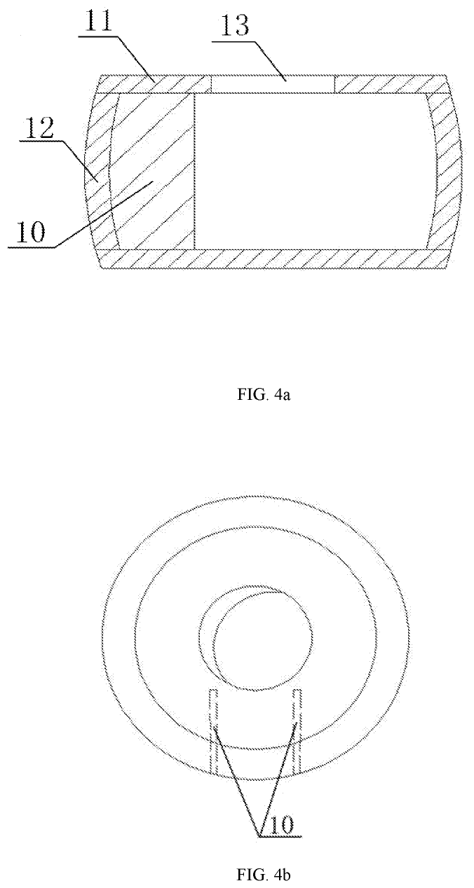

As shown in FIGS. 4 and 4a, a ribbed drum-shaped spherical shell is only provided with parallel double ribs 10 on both sides of the bolt hole perpendicular to the direction of the cover plate, and other parts are the same as those of an unribbed drum-shaped spherical shell.

As shown in FIGS. 3b and 4b, the middle of the circular plane cover plate on one side is provided with a mounting hole 13, so that the curved European nut 2 is placed into the drum-shaped spherical shell 1, and an operation space is provided for installation. In order to ensure that the circular plane cover plate is stressed, a diameter D′ of the mounting hole 13 should be greater than an external diameter d of the curved European nut and smaller than ½ of an external diameter of the circular plane cover plate.

In order to prevent the inside of the joint with the drum-shaped spherical shell from rusting, a sealing plate with a diameter greater than that of the mounting hole is added outside the mounting hole 13. The sealing plate and the circular plane cover plate are provided with four threaded holes according to a cross, and the two plates are connected by countersunk screws.

As shown in FIGS. 3 and 4, the spherical connecting surface 12 is provided with a bolt connecting hole 14, and the diameter of the connecting hole is equal to d+4 mm (d is the diameter of the high-strength bolt 3 for space trusses). The bolt 3 can be finely adjusted within 2 mm, and it is ensured that the circular steel tube is not subjected to eccentricity during installation.

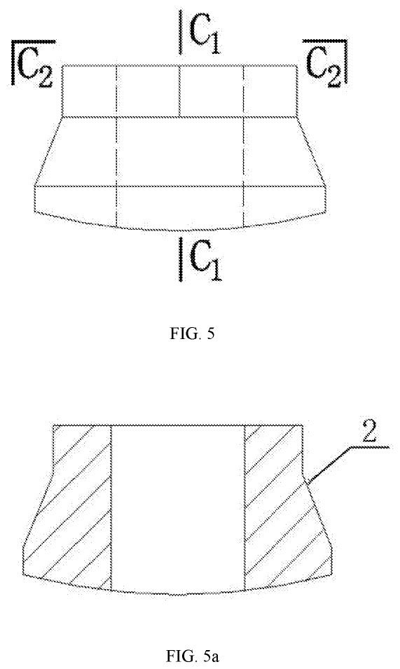

As shown in FIGS. 5 and 5a, a bottom end of the curved European nut is provided with a curved surface, and its radius of curvature is the same as the radius of curvature of the spherical connecting surface, so that the curved European nut 2 can be attached to the spherical connecting surface 12.

As shown in FIGS. 5 and 5b, a top end of the curved European nut is a hexagonal prism. During installation, an L-shaped wrench can extend into the drum-shaped spherical shell 1 from the mounting hole 13 to fix the nut 2, so that the high-strength bolt 3 for space trusses can be screwed into the curved European nut 2 conveniently.

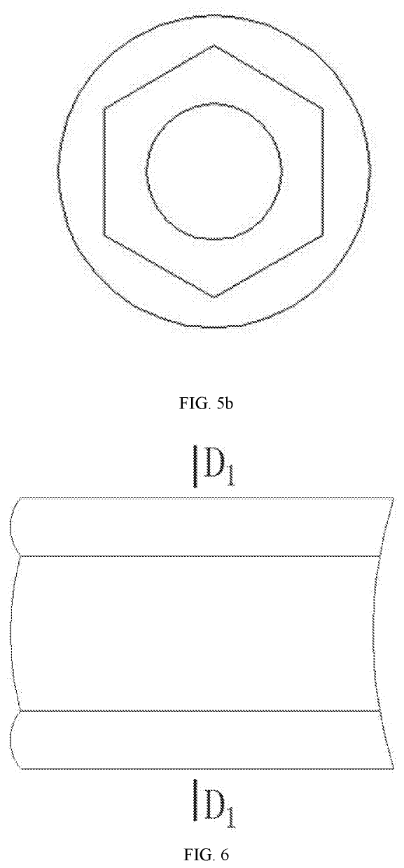

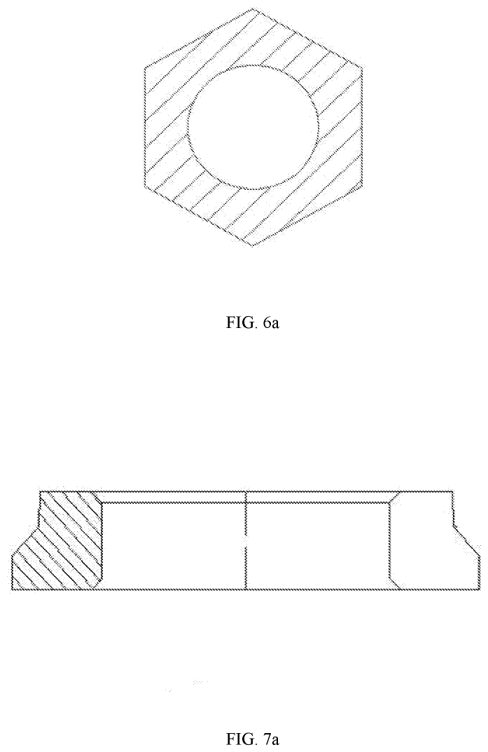

As shown in FIG. 6, a side of the sleeve 4 in contact with the spherical connecting surface 12 needs to be milled to form a spherical surface that is matched with the surface of the shell. Alternatively, the sleeve is a standard part, and a single-sided concave washer is arranged between the sleeve and the spherical connecting surface of the drum-shaped spherical shell.

As shown in FIG. 6a, the outer surface of the sleeve 4 is provided with a regular hexagon for screwing the high-strength bolt 3 for space trusses.

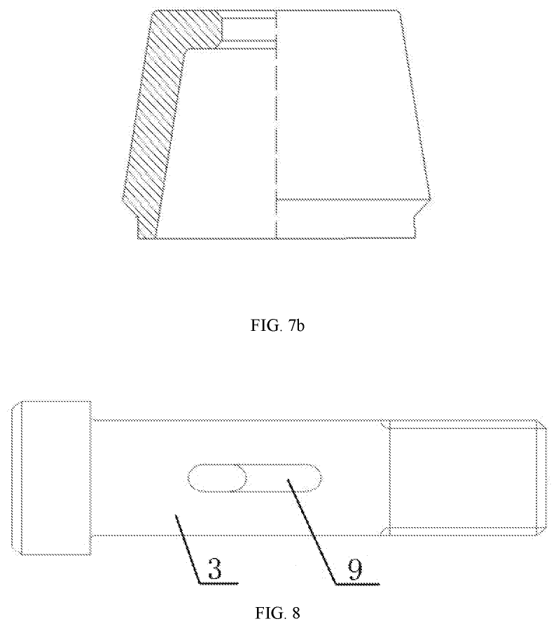

When a tube diameter of the circular steel tube 7 is greater than 76 mm, the conehead 6 (as shown in FIG. 7b) is usually selected for connection; and when the tube diameter of the circular steel tube 7 is less than or equal to 76 mm, the sealing plate 5 (as shown in FIG. 7a) is usually selected for connection, and the circular steel tube 7 is welded to the sealing plate 5 (or the conehead 6).

As shown in FIG. 8, a screw of the high-strength bolt 3 for space trusses is provided with a key groove 9 (a sliding groove JG/T 10-2009) where the fastening screw is clamped, which is used for fixedly connecting the sleeve 4 to the preset high-strength bolt 3 for space trusses through the fastening screw.

The value range of N which is the number of the connecting member 8 depends on the position of the joint in a steel tube brace system, and the drum-shaped spherical shell 1 may be in various forms such as “corner drum”, “half drum” and “full drum”.

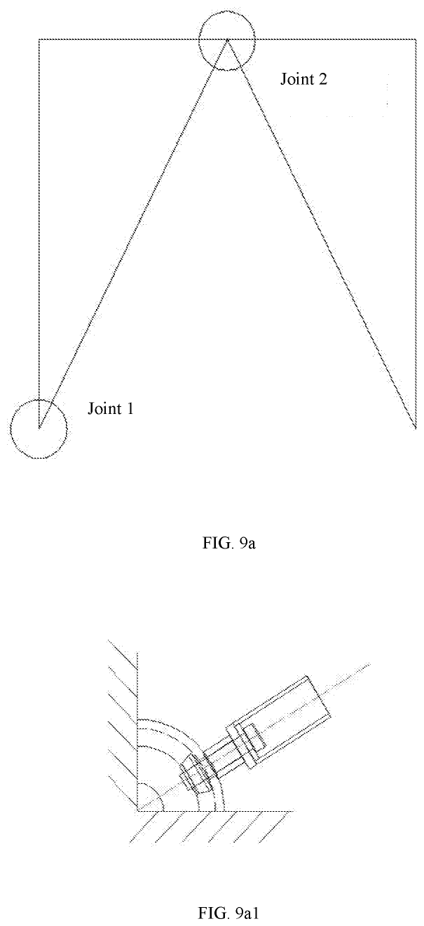

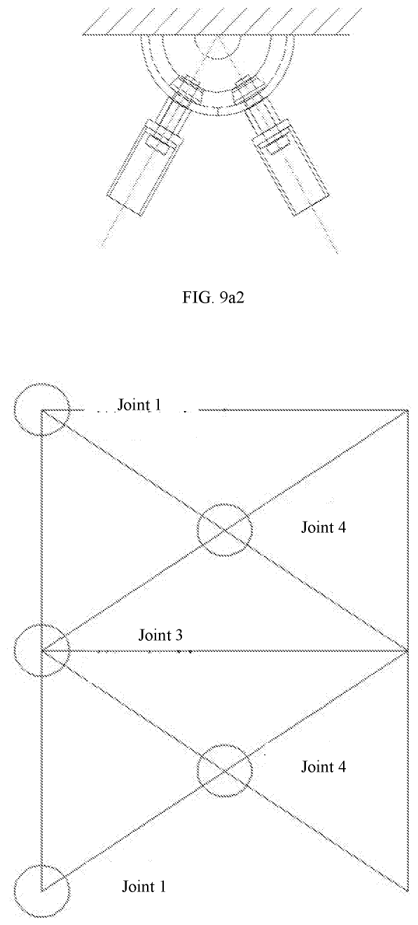

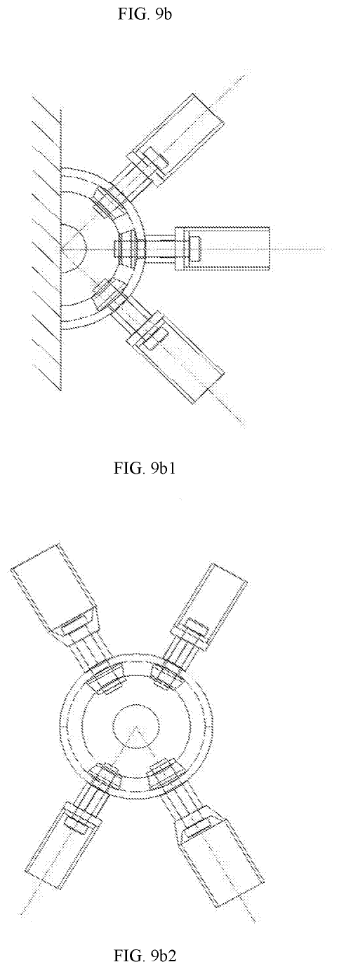

When the single-layer brace shown in FIG. 9a is adopted, as shown in FIG. 9a1, a “corner drum” joint 1 is provided with a connecting member 8; and as shown in FIG. 9a2, a “half drum” joint 2 is provided with two connecting members 8.

When the double-layer brace shown in FIG. 9b is adopted, as shown in FIG. 9b1, a “half drum” joint 3 is provided with three connecting members 8; and as shown in FIG. 9b2, a “full drum” joint 4 is provided with four connecting members 8.

In summary, in the present invention, according to different positions of the joint in a bracing system, there are three forms: the corner drum, the half drum and the full drum. In practical application, the specifications of the high-strength bolt for space trusses are determined, and the geometric dimensions of each part of the joint and the tensile and compressive bearing capacity of the joint are selected. The bolted joint with a drum-shaped spherical shell for connecting a circular steel tube brace has clear force transmission and a small deviation between theoretically analyzed stress and actual stress; has no eccentricity, can be finely adjusted and has reliable mechanical performance; is in bolted connection and is installed efficiently; and is not convex, thereby facilitating wallboard installation and indoor decoration.

Finally, it should be noted that the above examples are only intended to explain, rather than to limit the technical solutions of the present invention. Although the present invention is described in detail with reference to the examples of the present invention, those of ordinary skill in the art should understand that modifications or equivalent replacements may be made to the technical solutions of the present invention without departing from the spirit and scope of the technical solutions of the present invention, and such modifications or equivalent replacements should fall within the protection scope of the present invention.

What is claimed is:

1. A bolted joint with a drum-shaped spherical shell for connecting a circular steel tube brace, the bolted joint comprising:
a drum-shaped spherical shell; and
a plurality of connecting members, wherein
the drum-shaped spherical shell is formed by:
an upper-end circular plane cover plate; and
a lower-end circular plane cover plate having a spherical connecting surface connected therebetween, wherein a center of the upper-end or lower-end circular plane cover plate is provided with a mounting hole, the spherical connecting surface is provided with one or more connecting holes, and centers of the plurality of connecting holes are positioned on the same connecting plane;
the connecting members each comprise:
a curved European nut;
a high-strength bolt for space trusses;
a sleeve;
a sealing plate or a conehead; and
a circular steel tube, wherein the high-strength bolt for space trusses is pre-installed at one end of the circular steel tube through the sealing plate or the conehead, the sleeve sleeves the high-strength bolt for space trusses through a fastening screw, and a free end of the high-strength bolt for space trusses passes through the connecting holes in the spherical connecting surface of the drum-shaped spherical shell and then is fixed by the curved European nut; and
the plurality of connecting members are centered on the spherical connecting surface of the drum-shaped spherical shell.

2. The bolted joint with a drum-shaped spherical shell for connecting a circular steel tube brace according to claim 1, wherein parallel double ribs are arranged on two sides of the connecting hole located in the spherical connecting surface in the drum-shaped spherical shell.

3. The bolted joint with a drum-shaped spherical shell for connecting a circular steel tube brace according to claim 1, wherein a sealing plate is disposed outside the mounting hole of the circular plane cover plate.

4. The bolted joint with a drum-shaped spherical shell for connecting a circular steel tube brace according to claim 1, wherein a thickness of the circular plane cover plate is greater than a wall thickness of the spherical connecting surface.

5. The bolted joint with a drum-shaped spherical shell for connecting a circular steel tube brace according to claim 1, wherein a diameter of the mounting hole is greater than an external diameter of the curved European nut, and is ½ of an external diameter of the circular plane cover plate.

6. The bolted joint with a drum-shaped spherical shell for connecting a circular steel tube brace according to claim 1, wherein a diameter d′ of the connecting hole in the spherical connecting surface is equal to d+4 mm, wherein d is a diameter of the high-strength bolt for space trusses.

7. The bolted joint with a drum-shaped spherical shell for connecting a circular steel tube brace according to claim 1, wherein a top end of the curved European nut is a hexagonal prism.

8. The bolted joint with a drum-shaped spherical shell for connecting a circular steel tube brace according to claim 1, wherein when a tube diameter of the circular steel tube is greater than 76 mm, the conehead is selected for connection, and when the tube diameter of the circular steel tube is less than or equal to 76 mm, the sealing plate is selected for connection.

9. The bolted joint with a drum-shaped spherical shell for connecting a circular steel tube brace according to claim 1, wherein one side of the sleeve in contact with the spherical connecting surface is provided with a spherical surface matched with the surface of the sleeve; or a single-sided concave washer is arranged between the sleeve and the spherical connecting surface.
